(19) United States
(12) Patent Application Publication
(10) Pub. No.: US 2026/0044247 A1
(43) Pub. Date: Feb. 12, 2026

(54) INFORMATION PRESENTATION METHOD, COMPUTER DEVICE AND STORAGE MEDIUM

(71) Applicant: Beijing Zitiao Network Technology Co., Ltd., Beijing (CN)

(72) Inventors: Yuxing LIU, Beijing (CN); Yaoting ZHONG, Beijing (CN)

(21) Appl. No.: 19/100,938

(22) PCT Filed: Mar. 27, 2024
(86) PCT No.: PCT/CN2024/084033

§ 371 Date: Feb. 4, 2025

(30) Foreign Application Priority Data
Apr. 25, 2023 (CN) 202310457940.2

(51) Int. Cl. G06F 3/0482

(52) U.S. Cl. CPC G06F 3/0482

(57) ABSTRACT

An information presentation method, a computer device, and a storage medium are provided, where the information presentation method includes: presenting, on an information list page, a plurality of first information contents, where the first information contents have a preset first information structure; obtaining, in response to a trigger operation for any one of the first information contents, a second information content corresponding to the first information content, where the second information content has a preset second information structure, the second information structure has a different form of presenting a target key content in a content detail corresponding to the first information content as compared to the first information structure, and the target key content is related to an information distribution genre of the first information content; and updating and presenting the second information content at a position of the first information content.

This application claims priority to Chinese Patent Application No. 202310457940.2, filed on Apr. 25, 2023, the content of which is herein incorporated by reference in its entirety as part of this application.

### TECHNICAL FIELD

Embodiments of the present disclosure relate to an information presentation method and apparatus, a computer device, and a storage medium.

### BACKGROUND

A list page may be used for presenting the respective information contents in an information flow. For example, novel recommendation information (e.g., covers, brief, and names) corresponding to multiple novels respectively is presented on the list page. However, when presenting the information contents through the list page, the content information presented on the list page is very limited due to the impact of the presentation efficiency of a presentation device.

Therefore, if target key information (e.g., important information that a user wants to focus on) related to any information content presented on the list page needs to be obtained, it is usually necessary to realize it by jumping to a landing page corresponding to the information content. However, the way of jumping to the landing page has the problems of long waiting time and excess presentation resources, which affects the efficiency in obtaining the key information.

### SUMMARY

Embodiments of the present disclosure provide at least an information presentation method and apparatus, a computer device, and a storage medium.

In a first aspect, embodiments of the present disclosure provide an information presentation method. The method includes:
presenting, on an information list page, a plurality of first information contents, wherein the first information contents have a preset first information structure;
obtaining, in response to a trigger operation for any one of the first information contents, a second information content corresponding to the first information content, wherein the second information content has a preset second information structure, the second information structure has a different form of presenting a target key content in a content detail corresponding to the first information content as compared to the first information structure, and the target key content is related to an information distribution genre of the first information content; and
updating and presenting the second information content at a position of the first information content.

In a possible embodiment, respective content distribution dimensions corresponding to the first information structure are the same as or different from respective content distribution dimensions corresponding to the second information structure; under different information distribution genres, a target content distribution dimension to which the target key content belongs is different.

In a possible embodiment, in case of the information distribution genre being a text content category, the target content distribution dimension is a brief dimension;
in case of the information distribution genre being a movie or television drama category, the target content distribution dimension is a video dimension;
in case of the information distribution genre being a serials category, the target content distribution dimension is a catalog dimension; and
in case of the information distribution genre being an audio program category, the target content distribution dimension is an audio dimension.

In a possible embodiment, in case of the information distribution genre being a text content category, presenting, on an information list page, a plurality of first information contents comprises:
presenting, on the information list page, a plurality of first information content cards, the first information content cards each presenting a title, a cover, and a part of brief information of the first information contents, wherein a sum of sizes of the title and the cover in a horizontal direction of the page, as well as a sum of sizes of the cover and the part of brief information in the horizontal direction of the page, is equal to a width of the first information content card in the horizontal direction of the page, respectively;
updating and presenting the second information content at a position of the first information content comprises:
replacing each first information content card with a second information content card, the second information content card presenting a title, a cover, and complete brief information of the second information content; wherein a size of the complete brief information in the horizontal direction of the page is equal to a width of the second information content card in the horizontal direction of the page; and the sum of sizes of the title and the cover is equal to the width of the second information content card in the horizontal direction of the page.

In a possible embodiment, in case of the information distribution genre being a movie or television drama category, presenting, on an information list page, a plurality of first information contents, comprises:
presenting, on the information list page, a plurality of first information content cards, the first information content cards each presenting a video title, a video cover, and a part of brief information of the first information contents, wherein a sum of sizes of the video title and the video cover in a horizontal direction of the page, as well as a sum of sizes of the video cover and the part of brief information in the horizontal direction of the page is equal to a width of the first information content card in the horizontal direction of the page, respectively;
updating and presenting the second information content at a position of the first information content comprises:
replacing each first information content card with a second information content card, the second information content card presenting a video title, a preview video in a playing state, and a part of brief information of the second information content, wherein occupancy sizes of the video title, the preview video, and the part of brief information in the horizontal direction of the page are each equal to a width of the second information content card in the horizontal direction of the page.

In a possible embodiment, in case of the information distribution genre being an audio program category, presenting, on an information list page, a plurality of first information contents, comprises:
presenting, on the information list page, a plurality of first information content cards, the first information content cards each presenting a title, a cover, and a part of brief information of the first information contents, wherein a sum of occupancy sizes of the title and the cover in a horizontal direction of the page and a sum of occupancy sizes of the cover and the part of brief information in the horizontal direction of the page is equal to a width of the first information content card in the horizontal direction of the page;
updating to present the second information content at the position of the first information content comprises:
replacing each first information content card with a second information content card, the second information content card presenting a title, a cover and complete brief information of the second information contents and a plurality of playable audio clips; wherein a sum of sizes of the plurality of audio clips in the horizontal direction of the page, or the size of the complete brief information in the horizontal direction of the page, is equal to a width of the second information content card in the horizontal direction of the page, respectively, and a sum of sizes of the title and the cover in the horizontal direction of the page is equal to the width of the second information content card in the horizontal direction of the page.

In a possible embodiment, the trigger operation comprises an operation of triggering an information presentation button associated with the first information contents;
presenting, on an information list page, a plurality of first information contents comprises:
presenting, on the information list page, a plurality of the first information contents, and presenting, at a position corresponding to the target content distribution dimension in the first information contents, an information presentation button corresponding to the target content distribution dimension;
obtaining, in response to a trigger operation for any one of the first information contents, a second information content corresponding to the first information content comprises:
obtaining, in response to triggering the information presentation button corresponding to any one of the first information contents, a second information content corresponding to the first information content.

In a possible implementation, the trigger operation comprises receiving a target gesture operation;
obtaining, in response to a trigger operation for any one of the first information contents, a second information content corresponding to the first information content comprises:
obtaining, in response to receiving the target gesture operation, a second information content corresponding to the first information content; wherein the target content distribution dimension of target content information in the second information content is related to the target gesture operation and the information distribution genre.

In a second aspect, embodiments of the present disclosure provide an information presentation apparatus, comprising:
a first presentation module, configured to present, on an information list page, a plurality of first information contents, wherein the first information contents have a preset first information structure;
an obtaining module, configured to obtain, in response to a trigger operation for any one of the first information contents, a second information content corresponding to the first information content, wherein the second information content has a preset second information structure, the second information structure has a different form of presenting a target key content in a content detail corresponding to the first information content as compared to the first information structure, and the target key content is related to an information distribution genre of the first information content; and
a second presentation module, configured to update and present the second information content at a position of the first information content.

In a third aspect, an optional implementation of the present disclosure provides a computer device, a processor and a memory, wherein the memory stores machine-readable instructions executable by the processor, the processor is configured to execute the machine-readable instructions stored in the memory, and when the machine-readable instructions are executed by the processor, the processor performs the steps of the first aspect or any of the possible embodiments of the first aspect.

In a fourth aspect, an optional implementation of the present disclosure provides a computer-readable storage medium, wherein the computer-readable storage medium stores a computer program which, when executed by a computer device, causing the computer device to perform the steps of the first aspect or any of the possible embodiments of the first aspect.

Descriptions of the effects of the aforementioned information presentation apparatus, computer device, and computer-readable storage medium refer to the explanation provided for the information presentation method above, which will not be repeated here. Embodiments of the present disclosure provide an information presentation method and apparatus, a computer device, and a storage medium. Since a second information structure has a different form of presenting a target key content in a content detail corresponding to a first information content as compared to a first information structure, after the first information content is triggered, by obtaining a second information content having the second information structure and presenting the second information content at the position of the first information content, not only the interaction structures can be innovated and the key content can be presented completely, but also the target key content related to an information distribution genre of the first information content can be highlighted without the need of jumping to the landing page, which effectively shortens an interaction path of obtaining the key content and improves the efficiency in obtaining the key content. By changing the information structure, the information content presented can be enriched while considering the limited space of a presentation device, thus effectively improving the presentation efficiency of the presentation device. Moreover, since different target key contents are related to the information distribution genre of the first information content, different information distribution genres may correspond to different target key contents. In this way, information having different information distribution genres may be realized, and the different target key contents may be highlighted, thus improving the flexibility of presenting the target key contents.

In order to make the above purposes, features and advantages of the present disclosure more obvious and understandable, a better embodiment is given below, with the accompanying drawings, as detailed below.

### BRIEF DESCRIPTION OF DRAWINGS

In order to more clearly illustrate the technical solutions of the embodiments of the present disclosure, the drawings required to be used in the embodiments will be briefly introduced below. The drawings herein are incorporated into, and form part of, the description. These drawings show the embodiments that conform to the present disclosure and are used together with the description to illustrate the technical solutions of the present disclosure. It should be understood that the following drawings only show some embodiments of the present disclosure and therefore should not be regarded as limiting the scope, and that for those ordinary skilled in the art, other relevant drawings may also be attained from those drawings without creative effort.

FIG. 1 shows a flowchart of an information presentation method according to an embodiment of the present disclosure;

FIG. 2 shows a schematic diagram of an information list page according to an embodiment of the present disclosure;

FIG. 3 shows a schematic diagram of a plurality of information content cards of a text content category presented according to an embodiment of the present disclosure;

FIG. 4 shows a schematic diagram of updating of a presentation structure corresponding to novels according to an embodiment of the present disclosure;

FIG. 5 shows a schematic diagram of updating of a presentation structure corresponding to movie or television dramas according to an embodiment of the present disclosure;

FIG. 6 shows a schematic diagram of updating of a presentation structure corresponding to audio programs according to an embodiment of the present disclosure;

FIG. 7 shows a schematic diagram of an information presentation apparatus according to an embodiment of the present disclosure; and

FIG. 8 shows a schematic structural diagram of a computer device according to an embodiment of the present disclosure.

### DETAILED DESCRIPTION

In order to make the objectives, technical solutions, and advantages of the embodiments of the present disclosure clearer, the technical solutions in the embodiments of the present disclosure are clearly and completely described below with reference to the drawings in the embodiments of the present disclosure. Apparently, the described embodiments are merely a part rather than all of the embodiments of the present disclosure. Generally, the components of the embodiments of the present disclosure described and shown may be arranged and designed in various manners. Therefore, the detailed description of the embodiments of the present disclosure is not intended to limit the protection scope of the present disclosure, but merely to represent the selected embodiments of the present disclosure. All other embodiments derived from the embodiments of the present disclosure by those of ordinary skilled in the art without creative efforts shall fall within the protection scope of the present disclosure.

In addition, the terms “first”, “second”, etc. in the specification and claims in the present disclosure and in the drawings above are used to distinguish similar objects and are not necessarily used to describe a particular order or sequence. It should be understood that the data thus used are interchangeable where appropriate so that the embodiments described herein can be implemented in an order other than what is illustrated or described here.

Herein, the term “a plurality of or several” refers to two or more. “And/or” describes the association relationship of the associated object, indicating that there can be three kinds of relationships, for example, A and/or B, can be: A exists alone, A and B exist simultaneously, and B exists alone. The character “/” generally indicates that the associated object is an “or” relationship.

It is found that for a plurality of information contents presented on the list page, content dimensions presented corresponding to the respective information contents and presentation structures of content information under the respective content dimensions are the same, and information obtained from a list page by a user is limited, which often cannot help the user to better consume information. Therefore, if the user wants to make a consumption decision for the information content, he/she often needs to jump to a landing page to obtain more key information related to the information content and make a consumption strategy based on information on the landing page. However, the way of jumping to the landing page has problems of long waiting time and excess presentation resources, which affects the efficiency in obtaining the key information.

Based on the above research, the present disclosure provides an information presentation method and apparatus, a computer device, and a storage medium. Since a second information structure has a different form of presenting a target key content in a content detail corresponding to a first information content as compared to a first information structure, after the first information content is triggered, by obtaining a second information content having the second information structure and presenting the second information content at the position of the first information content, not only the interaction structures can be innovated and the key content can be presented completely, but also the target key content related to an information distribution genre of the first information content can be highlighted without the need of jumping to the landing page, which effectively shortens an interaction path of obtaining the key content and improves the efficiency in obtaining the key content. By changing the information structure, the information content presented can be enriched while considering the limited space of a presentation device, thus effectively improving the presentation efficiency of the presentation device. Moreover, since different target key contents are related to the information distribution genre of the first information content, different information distribution genres may correspond to different target key contents. In this way, information having different information distribution genres may be realized, and the different target key contents may be highlighted, thus improving the flexibility of presenting the target key contents.

The defects of the above-mentioned solution are the result of the inventor's practice and careful study, and therefore, the process of discovering the above-mentioned problems and the solution proposed in the present disclosure below to address the above-mentioned problems should be the inventor's contribution to the present disclosure in the course of the present disclosure.

It should be noted that similar signs and letters denote similar items in the following accompanying drawings, and therefore, once an item is defined in a figure, it does not need to be further defined or explained in the subsequent figures.

It can be understood that before using the technical solutions disclosed in each embodiment of the present disclosure, the user should be informed of the type of personal information involved in the present disclosure, the scope of application, the use scenarios, etc., in accordance with the associated laws and regulations and obtain the user authorization in an appropriate manner.

In order to facilitate the understanding of the present embodiments, an information presentation method disclosed in embodiments of the present disclosure is first described in detail. The information presentation method provided in the embodiments of the present disclosure is generally executed by a terminal device or other processing device having certain computing power. The terminal device may be UE (User Equipment), a mobile device, a user terminal, a terminal, a PDA (Personal Digital Assistant), a handheld device, a computer device, and the like. In some possible implementations, the information presentation method may be implemented by a processor calling computer-readable instructions stored in a memory.

The information presentation method provided in the embodiments of the present disclosure is described below taking an example in which the execution subject is a computer device.

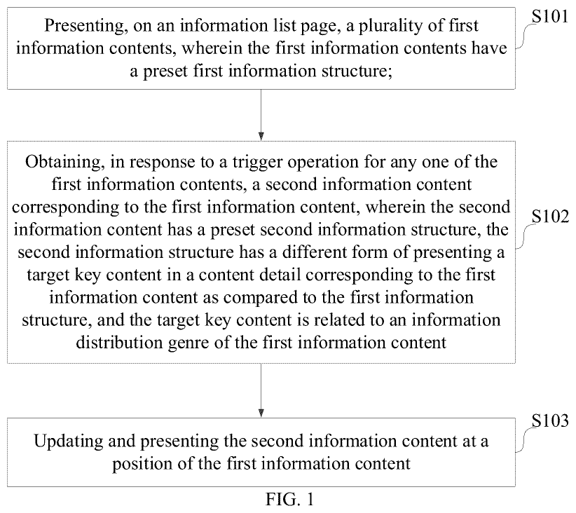

A flowchart of an information presentation method according to an embodiment of the present disclosure is shown in FIG. 1, which may include the following steps.

S101: presenting, on an information list page, a plurality of first information contents, where the first information contents have a preset first information structure.

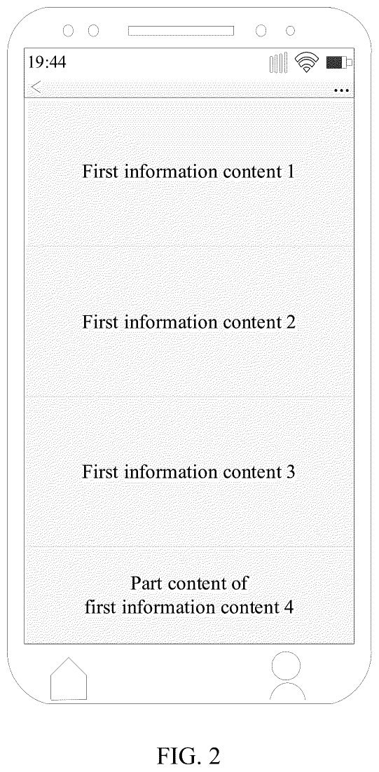

Here, the information list page is used for presenting the respective information contents in an information flow, and the number of pieces of the information contents presented on the information list page each time may be determined according to the page size occupied by each piece of information content and a presentation space (i.e., a screen size) of the presentation device. The first information contents each may be presented in the form of an information content card, a first information content corresponds to an information content card, the size of the information content card corresponding to the first information content under different information distribution genres may be different, and the size of the information content card corresponding to the first information content under the same information distribution genre may be the same. FIG. 2 shows a schematic diagram of an information list page according to an embodiment of the present disclosure, in which four first information contents (i.e., first information contents 1-4) are presented, each first information content corresponds to an information content card, and an information content card corresponds to a presentation position in the list page, occupying a certain presentation area. Due to the limitation of the presentation space of the presentation device, the first information content 4 is only partially presented.

The first information contents have a preset first information structure and are the information content presented on the list page. The first information structure may correspond to multiple content distribution dimensions, and the content distribution dimensions are used for representing dimensions corresponding to the distributed information, such as a cover dimension, a title dimension, a video dimension, a brief dimension, a catalog dimension, and an audio clip dimension. A content distribution dimension corresponds to one type of information content in a content detail of the first information content, the content detail is the entire content associated with a subject corresponding to the first information content. For example, in response to the subject corresponding to the first information content being a novel, the content detail refers to all content related to the novel. The first information structure is used for representing the presentation form and positional relationship of the information content under each content distribution dimension in the first information content, and the presentation form may include, for example, presentation position, and presentation size, etc. Taking the first information content being a novel as an example, the first information content may include a title of the novel under the title dimension, a cover of the novel under the cover dimension, and a part of brief information under the brief dimension, and the first information structure is used for indicating the presentation form corresponding to the title of the novel, the cover of the novel, and the part of the brief information, respectively, as well as the positional relationship among the three.

Different first information contents may have different information distribution genres, and the information distribution genres are used for representing the information types of the first information contents. Illustratively, the information distribution genre may include a text content category (e.g., novels, and books), a movie or television drama category, a serials category, an audio program category, etc.

The plurality of first information contents presented on the information list page may be information contents having the same information distribution genre, for example, the plurality of first information contents presented on the information list page are all information contents corresponding to different novels. Optionally, the plurality of first information contents presented on the information list page may also be information contents having different information distribution genres, for example, a first information content presented on the information list page is an information content corresponding to a novel, a second first information content is an information content corresponding to a movie or television drama, and a third first information content is an information content corresponding to an audio.

In specific implementation, in response to a loading operation of the information list page, the respective first information contents to be presented may be obtained from the information flow, and the respective first information contents may be presented on the information list page respectively in accordance with the first information structure and a presentation order of the respective first information contents.

S102: obtaining, in response to a trigger operation for any one of the first information contents, a second information content corresponding to the first information content, where the second information content has a preset second information structure, the second information structure has a different form of presenting a target key content in a content detail corresponding to the first information content as compared to the first information structure, where the target key content is related to the information distribution genre of the first information content.

Here, the second information content is the information content corresponding to the first information content and may be determined from the content detail based on the content detail corresponding to the first information content, and the type of the target key content corresponding to the information distribution genre of the first information content. The second information content has the preset second information structure, and the second information structure may also correspond to multiple content distribution dimensions. The respective content distribution dimensions corresponding to the first information structure may be the same as or different from the respective content distribution dimensions corresponding to the second information structure. Specifically, whether or not the respective content distribution dimensions corresponding to the first information structure are the same as the respective content distribution dimensions corresponding to the second information structure may be determined based on the information distribution genre of the first information content. For example, in case of the information distribution genre being a text content category, the respective content distribution dimensions corresponding to the first information structure and the respective content distribution dimensions corresponding to the second information structure may be the same; in case of the information distribution genre being a movie or television drama category, the respective content distribution dimensions corresponding to the first information structure and the respective content distribution dimensions corresponding to the second information structure may be different.

Since the second information structure has a different form of presenting a target key content in a content detail corresponding to the first information content as compared to the first information structure, by setting a different form of presenting the target key content, the target key content in the second information content can be highlighted. The target key content may be information to be highlighted in the second information content, and is related to the information distribution genre of the first information content. For example, in case of the information distribution genre being a novel, the target key content may be complete brief information, and in case of the information distribution genre being a movie or television drama, the target key content may be a preview video in a playing state.

The first information structure and the second information structure may be preset according to the information distribution genre, and the first information structure and the second information structure may be different under different information distribution genres.

With respect to the first information content and the second information content, the respective content distribution dimensions corresponding to the first preset structure of the first information content are related to the information distribution genre of the first information content, and the respective content distribution dimensions corresponding to the second preset structure of the second information content are also related to the information distribution genre of the first information content.

Under different information distribution genres, a target content distribution dimension to which the target key content belongs is different, and the target content distribution dimension is the content distribution dimension to which the target key content belongs. In specific implementation, in case of the information distribution genre being a text content category, the target content distribution dimension may be a brief dimension; for example, in case of the information distribution genre being a novel, the target content distribution dimension may be a brief dimension of the novel. In case of the information distribution genre being a movie or television drama, the target content distribution dimension may be a video dimension; for example, in case of the information distribution genre being a movie or television drama derived from a novel, the target content distribution dimension may be a video dimension corresponding to the movie or television drama. In case of the information distribution genre being a serials category, the target content distribution dimension may be a catalog dimension; for example, in case of the information distribution genre being a novel or a video of a serials category, the target content distribution dimension may be a catalog dimension corresponding to the novel or video of the serails category. In case of the information distribution genre being an audio program category, the target content distribution dimension may be an audio dimension; for example, in case of the information distribution genre being an audio novel, the target content distribution dimension may be an audio dimension corresponding to the novel.

Illustratively, with respect to different information distribution genres, the respective content distribution dimensions under the first information structure corresponding to the information distribution genre, the respective content distribution dimensions under the second information structure corresponding to the information distribution genre, and the target content distribution dimension to which the target key content belongs and corresponding to the information distribution genre may be preset.

In specific implementation, an information acquisition request may be sent to a server in response to the trigger operation for any of the first information content presented on the information list page. The server may, in response to the information acquisition request, determine the content distribution dimension corresponding to the second information structure based on the information distribution genre of the first information content, and then determine the second information content based on the information content under each content distribution dimension and the second information structure and then feed it back to a client. In this way, the client may obtain the second information content having the preset second information structure.

S103: updating and presenting the second information content at the position of the first information content.

In specific implementation, after the second information content is obtained, the second information content may be presented at the presentation position of the first information content in accordance with the second information structure, where the presentation position of the first information content is the position of the first information content on the information list page.

It should be noted that a second presenting area occupied by the second information content on the information list page (i.e., the size of the information card corresponding to the second information content) may be the same as or different from a first presenting area occupied by the first information content on the information list page (i.e., the size of the information card corresponding to the first information content). For example, the second presenting area may be larger than the first presenting area. If the second presenting area is different from the first presenting area, the presentation positions of the other first information contents presented on the information list page will also be adaptively adjusted (i.e., positions of the other information cards will be adaptively adjusted), so as to prevent overlapping of the second information content with another first information content or avoid a large blank area between the second information content and another first information content.

In this way, since the second information structure has a different form of presenting a target key content in a content detail corresponding to the first information content as compared to the first information structure, after the first information content is triggered, by obtaining the second information content having the second information structure and presenting the second information content at the position of the first information content, not only the interaction structures can be innovated and the key content can be presented completely, but also the target key content related to the information distribution genre of the first information content can be highlighted without the need of jumping to the landing page, which effectively shortens an interaction path of obtaining the key content and improves the efficiency in obtaining the key content. By changing the information structure, the information content presented can be enriched while considering the limited space of the presentation device, thus effectively improving the presentation efficiency of the presentation device. Moreover, different target key contents are related to the information distribution genre of the first information content, and different information distribution genres may correspond to different target key contents. In this way, information having different information distribution genres may be realized, and the different target key contents may be highlighted, thus improving the flexibility of presenting the target key contents.

It should be noted that after the first information content is replaced with the second information content, a content detail page corresponding to the first information content may also be presented in response to a trigger operation directed to a target position of the second information content.

In one embodiment, in case of the information distribution genre being the text content category, for S101, the following steps may be performed:
presenting, on the information list page, a plurality of first information content cards, the first information content cards each presenting a title, a cover, and a part of brief information of the first information contents, where the sum of the occupancy sizes of the title and the cover in a horizontal direction of the page, or the sum of the occupancy sizes of the cover and the part of brief information in the horizontal direction of the page is equal to the width of the first information content card in the horizontal direction of the page, respectively.

Here, the information content of the text content category may be, for example, a novel. The first information content card is used for presenting the first information content, where a title, a cover, and a part of brief information of the first information content may be presented. The occupancy size may include an occupancy size in the horizontal direction of the page and an occupancy size in a vertical direction of the page. The occupancy size in the horizontal direction of the page is used for representing the width of the page occupied by the information content under a certain content distribution dimension. Similarly, the occupancy size in the vertical direction of the page is used for representing the height of the information content on the page under a certain content distribution dimension. In specific implementation, the width of each first information content card may be the same as the width of the page and the height may be less than the height of the page, and accordingly, the occupancy size may also be used for representing the width of the information content under a certain content distribution dimension that is occupied in the horizontal direction of the first information content card and the height of the first information content card that is occupied in the vertical direction.

For the title, the cover, and the part of brief information of the first information content, the title of the first information content may be located on the right side of the cover and above the part of brief information, and the part of brief information may be located on the right side of the cover. The occupancy size of the cover in the vertical direction of the page may be equal to the sum of the occupancy sizes of the title and the part of brief information in the vertical direction of the page.

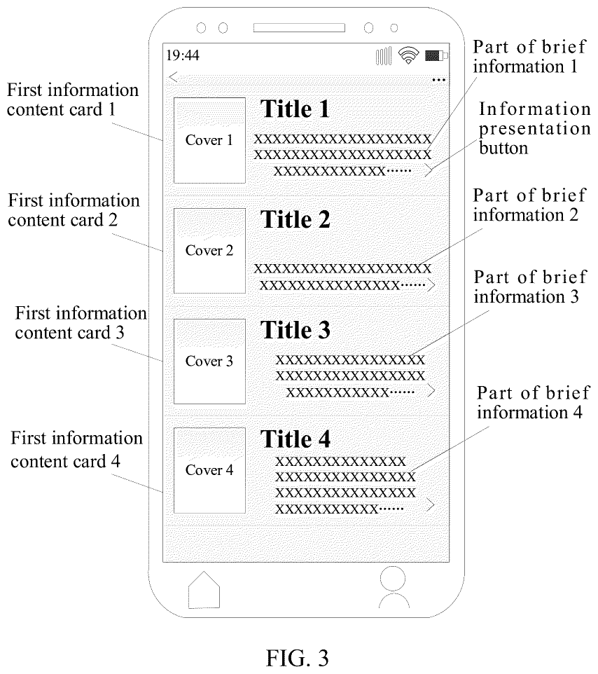

It should be noted that the occupancy size of the information content under any of the content distribution dimensions may be determined based on the width and height of the information content and the width of the blank area occupied by the information content. FIG. 3 shows a schematic diagram of presenting a plurality of first information content cards of a text content category according to an embodiment of the present disclosure. In FIG. 3, the first information content of the text content category is the first information content corresponding to novels. In FIG. 3, there are four first information content cards (i.e., first information content cards 1-4) corresponding to four novels (i.e., novels 1-4), and each of the first information content cards presents a title of the novel (i.e., titles 1-4), a cover (i.e., covers 1-4), and a part of the brief information (i.e., part of brief information 1-4). For the novel 1, the occupancy size of the title 1 may be a size corresponding to a dashed box 1, the occupancy size of the title 1 in the horizontal direction of the page is a width corresponding to the dashed box 1, and the occupancy size of the title 1 in the vertical direction of the page is a height corresponding to the dashed box 1; the occupancy size of the cover 1 may be a size corresponding to a dashed box 2, the occupancy size of the cover 1 in the horizontal direction of the page is a width corresponding to the dashed box 2, the occupancy size of the cover 1 in the vertical direction of the page is a height corresponding to the dashed box 2; the occupancy size of the part of brief information 1 may be a size corresponding to a dashed box 3, the occupancy size of the part of brief information 1 in the horizontal direction of the page is a width corresponding to the dashed box 3, and the occupancy size of the part of brief information 1 in the vertical direction of the page is a height corresponding to the dashed box 3. Moreover, for each novel, the font size of the title in the first information content may be larger than the font size of the part of brief information, and the font of the title may be bolded.

Furthermore, for S103, the following steps may be performed:
replacing each first information content card with a second information content card, the second information content card presenting a title, a cover, and complete brief information of the second information content; where the occupancy size of the complete brief information in the horizontal direction of the page is equal to the width of the second information content card in the horizontal direction of the page; and the sum of the occupancy sizes of the title and the cover is equal to the width of the second information content card in the horizontal direction of the page.

Here, the second information content card is used for presenting the second information content corresponding to the text content type, and the target key content in the second information content may be the complete brief information under the brief dimension. The second information content may include a title, a cover, and complete brief information thereof. Illustratively, take the first information content of the text content category, which corresponds to a novel, as an example, the first information content may include a title of the novel, a cover of the novel, and a part of brief information of the novel, and the second information content may include a title of the novel, a cover of the novel, and a complete brief information of the novel. In the second information content, the font size of the complete brief information may be larger than the font size of the title, and is also bolded, the complete brief information may be located underneath the title and the cover, the complete brief information occupies an area in the second information content card that is larger than the sum of the areas occupied by the title and the cover, the cover will be reduced, and the occupancy size will also be reduced.

In specific implementation, the second information content card may be obtained and the first information content card may be replaced with the second information content card in response to a trigger operation for the first information content card by the user. The trigger operation for the first information content card may be, for example, an operation of clicking, double-clicking on any position of the first information content card, such as an operation of triggering an information presentation button in the first information content card.

For the information distribution genre being the text content category, the content distribution dimensions corresponding to the first information structure and the second information structure may be the same, but the presentation position and style of the information content under the respective content distribution dimensions are changed, and thus the highlighting of the target key content can be realized.

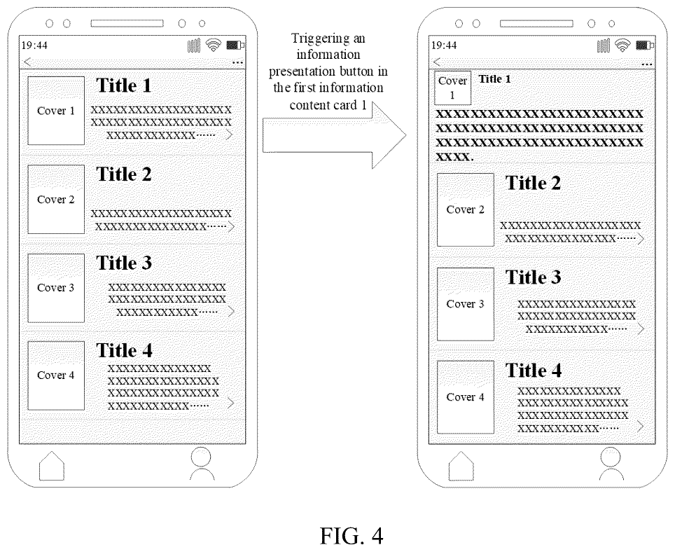

FIG. 4 shows a schematic diagram of updating of a presentation structure corresponding to a novel according to an embodiment of the present disclosure. Here, a of FIG. 4 is FIG. 3, in which first information content cards (i.e., first information content cards 1-4) corresponding to four novels are presented. For the first information content cards 1-4, there exist second information content cards 1-4 corresponding thereto. After the novel 1 is triggered (i.e., an information presentation button in the first information content card 1 is triggered), the first information content card 1 will be replaced with the second information content card 1. b of FIG. 4 is a schematic diagram after the first information content card 1 is replaced with the second information content card 1, in which the area of the second information content card 1 is larger than the area of the first information content card 1, so that positions of the first information content cards 2-4 will be moved downwardly adaptively in b.

Based on the a and b of FIG. 4, it can be seen that by updating the first information structure to the second information structure and replacing the first information content card with the second information content card, the key information (e.g., the complete brief information in b of FIG. 4) in the novel can be highlighted, which further helps the user to learn more information about the novel, and helps the user to make a reading decision for the novel.

In another embodiment, in case of the information distribution genre being the movie or television drama category, for S101, the following steps may be performed:
presenting, on the information list page, a plurality of first information content cards, the first information content cards each presenting a video title, a video cover, and a part of brief information of the first information contents, where the sum of the occupancy sizes of the video title and the video cover in a horizontal direction of the page, or the sum of the occupancy sizes of the video cover and the part of brief information in the horizontal direction of the page, is equal to the width of the first information content card in the horizontal direction of the page, respectively.

Here, the movie or television drama category may be, for example, a movie or television drama derived from a novel, or may be any type of movie or television drama. In case of the information distribution genre being the movie or television drama category, the first information content card may present a video title, a video cover, and a part of brief information corresponding to the movie or television drama.

With respect to the video title, the video cover, and the part of brief information of the first information content, the video title of the first information content may be located on the right side of the video cover, the part of brief information may be located above the partial brief information, the part of brief information may be located on the right side of the video cover, and the occupancy size of the video cover in the vertical direction of the page may be equal to the sum of the occupancy sizes of the video title and the part of brief information in the vertical direction of the page.

In specific implementation, in response to a video acquisition operation, first information content cards corresponding to a plurality of videos may be presented on the information list page, and each of the first information content cards may include the video title, the video cover, and the part of brief information of the corresponding video.

Furthermore, for S103, the following steps may be performed:
replacing each first information content card with a second information content card, the second information content card presenting a video title, a preview video in a playing state, and a part of brief information of the second information content, where the occupancy sizes of the video title, the preview video, and the part of brief information in the horizontal direction of the page are each equal to the width of the second information content card in the horizontal direction of the page.

Here, the second information content card is used for representing the second information content corresponding to the genre of movie or television dramas, and the target key content in the second information content may be a preview video under the video dimension; the second information content may include a video title, a preview video in a playing state, and a part of brief information of the video. In case of the information distribution genre being the movie or television drama category, there is a difference between the content distribution dimension corresponding to the first information structure and the content distribution dimension corresponding to the second information structure. Specifically, the content distribution dimension corresponding to the first information structure may be a title dimension, a cover dimension, and a brief dimension, and the content distribution dimension corresponding to the second information structure may be a title dimension, a video dimension, and a brief dimension. The preview video in the second information content that is in the playing state may be located above the video title, the video title may be located above the part of the brief information, and the preview video in the playing state occupies the same size in the horizontal direction of the page as the video title occupies in the horizontal direction of the page and the part of the brief information occupies in the horizontal direction of the page.

For the information distribution genre being the movie or television drama category, there is a difference in the content distribution dimension corresponding to the first information structure and the second information structure, so that the highlighting of the target key content under the target content distribution dimension can be realized.

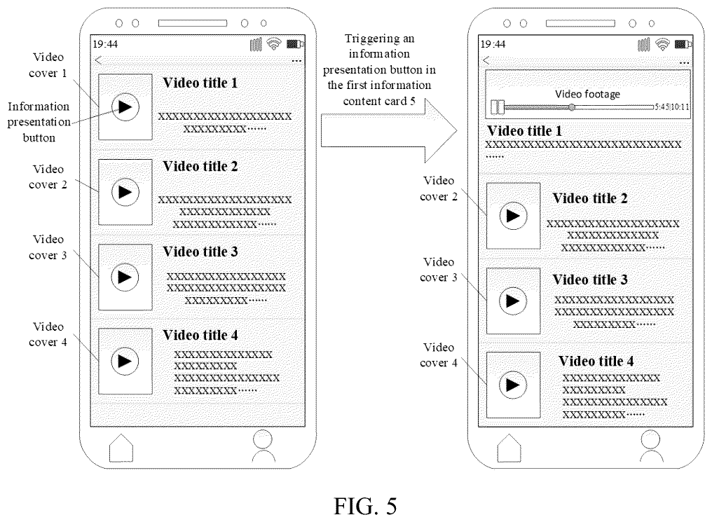

FIG. 5 shows a schematic diagram of updating of a presentation structure corresponding to movie or television dramas according to an embodiment of the present disclosure. First information content cards (first information content cards 5-8) corresponding to four movie or television dramas (i.e., movie or television dramas 1-4) are presented in c of FIG. 5, and each of the first information content cards presents a video title (i.e., video titles 1-4), a video cover (i.e., video covers 1-4), and a part of brief information of a video of the corresponding movie or television dramas. For the first information content cards 5-8, there exist second information content cards 5-8 corresponding thereto. After the movie drama 1 is triggered (e.g., after an information presentation button in the first information content card 5 is triggered), the first information content card 5 will be replaced with the second information content card 5. d of FIG. 5 is a schematic diagram after the first information content card 5 is replaced with the second information content card 5, in which the area of the second information content card 5 is larger than the area of the first information content card 5, and accordingly positions of the first information content cards 6-8 will be adaptively moved downwardly in d. Moreover, in d of FIG. 5, the preview video is a video in a playing state.

Based on the c and d of FIG. 5, it can be seen that by updating the first information structure to the second information structure and replacing the first information content card with the second information content card, the key information (e.g., the preview video in d of FIG. 5) in the movie or television drama can be highlighted, which helps the user to learn more information about the movie or television drama, and helps the user to make a viewing decision for the movie or television drama.

In another embodiment, the information distribution genre may further include the audio program category, in which case, for S101, the following steps may be performed:
presenting, on the information list page, a plurality of first information content cards, the first information content cards each presenting a title, a cover, and a part of brief information of the first information contents, where the sum of the occupancy sizes of the title and the cover in a horizontal direction of the page, or the sum of the occupancy sizes of the cover and the part of brief information in the horizontal direction of the page, is equal to the width of the first information content card in the horizontal direction of the page, respectively.

Here, the audio program category may refer to respective audio clips corresponding to a novel, or it may be any audio program. In case of the information distribution genre being the audio program category, the first information content card may present a title, a cover, and a part of brief information corresponding to the audio program. Illustratively, in case of the audio program being the respective audio clips corresponding to a novel, the title corresponding to the audio program may be a title of the novel, the cover corresponding to the audio program may be a cover of the novel, and the part of brief information corresponding to the audio program may be a part of brief information of the novel.

With respect to the title, the cover, and the part of brief information corresponding to the first information content, the title of the first information content may be located on the right side of the cover and above the part of brief information, the part of brief information may be located on the right side of the cover, and the occupancy size of the cover in the vertical direction of the page may be equal to the sum of the occupancy sizes of the title and the part of brief information in the vertical direction of the page. Moreover, for the title corresponding to the first information content, the font size of the title may be larger than the font size of the part of brief information, and the font of the title may be bolded. Illustratively, in case of the audio program category being the respective audio clips corresponding to a novel, the plurality of first information content cards of the audio program category presented may be as shown in FIG. 3.

Furthermore, for S103, the following steps may be performed:
replacing each first information content card with a second information content card, the second information content card presenting a title, a cover and complete brief information of the second information contents and a plurality of playable audio clips; where the sum of the occupancy sizes of the plurality of audio clips in the horizontal direction of the page, or the occupancy size of the complete brief information in the horizontal direction of the page, is equal to the width of the second information content card in the horizontal direction of the page, and the sum of the occupancy sizes of the title and the cover in the horizontal direction of the page is equal to the width of the second information content card in the horizontal direction of the page.

Here, the second information content card is used for presenting the second information content corresponding to the audio program category, and the target key content in the second information content may be audio information under the audio dimension. For example, the target key content may be at least one audio clip. The second information content may include a title of the audio program, a cover of the audio program, complete brief information of the audio program, and a plurality of playable audio clips. In case of the information distribution genre being the audio program category, there is a difference between the content distribution dimension corresponding to the first information structure and the content distribution dimension corresponding to the second information structure, specifically, the content distribution dimension corresponding to the first information structure may be a title dimension, a cover dimension, and a brief dimension, and the content distribution dimension corresponding to the second information structure may be a title dimension, a video dimension, a brief dimension, and an audio dimension. The content distribution dimensions corresponding to the second information structure are more than those corresponding to the first information structure. Here, the plurality of audio clips in the second information content may be located below the complete brief information, the font size of the complete brief information may be larger than the font size of the title and is also bolded, the complete brief information may be located below the title and the cover, the complete brief information occupies an area in the second information content card that is larger than the sum of the areas occupied by the title and the cover, the cover will be reduced, and the occupancy size will also be reduced.

For the information distribution genre being the audio program category, the content distribution dimensions corresponding to the second information structure are richer than the content separation dimensions corresponding to the first information structure, so the second information content is richer than the first information content. In this way, the first information content is replaced with the second information content, which not only improves the richness of the presented information, but also realizes the highlighting of the target key content under the target content distribution dimension.

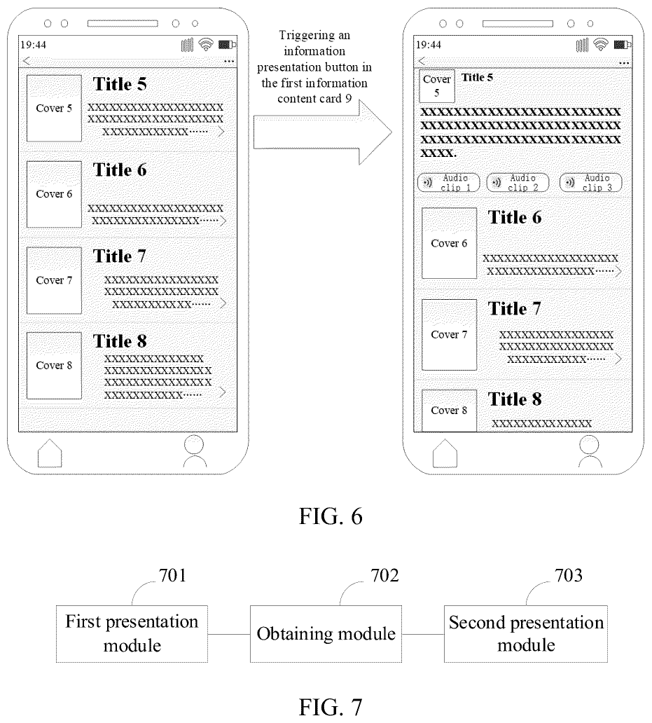

FIG. 6 shows a schematic diagram of updating of a presentation structure corresponding to an audio program according to an embodiment of the present disclosure. In e of FIG. 6, first information content cards (first information content cards 9-12) corresponding to four audio programs (i.e., audio programs 1-4) respectively are presented, and each of the first information content cards presents a title (i.e., titles 5-8), a cover (i.e., covers 5-8), and a part of brief information. For the first information content cards 9-12, there exist second information content cards 9-12 corresponding thereto. After the audio program 1 is triggered (e.g., an information presentation button in the first information content card 9 is triggered), the first information content card 9 will be replaced with the second information content card 9. f of FIG. 6 is a schematic diagram after the first information content card 9 is replaced with the second information content card 9, in which the area of the second information content card 9 is larger than the area of the first information content card 9, and accordingly, in f, positions of the first information content cards 10-12 will be moved downwardly adaptively, and the first information content 12 shows only part of the information. Moreover, in f of FIG. 6, three playable audio clips (i.e., audio clips 1-3) are shown. Furthermore, the audio clips may be played in response to a trigger operation directed to any of the audio clips in f.

It can be understood that the information distribution genre may further include the serails category, which may be, for example, a novel, an article, a comic, a video, and the like in serails. In case of the information distribution genre being the serails category, taking a serial novel as an example, for S101, a plurality of first information content cards may be presented on the information list page, and each of the first information content cards presents a title, a cover, and a part of the brief information of the novel; where the sum of the occupancy sizes of the title and the cover in the horizontal direction of the page, or the sum of the occupancy sizes of the cover and the part of brief information in the horizontal direction of the page is equal to the width of the first information content card in the horizontal direction of the page, respectively.

Furthermore, for S103, the first information content card may be replaced with the second information content card, the second information content card presents a title, a cover and complete brief information of the second information content and a plurality of triggerable novel catalogs, where the plurality of novel catalogs in the second information content may be the catalogs corresponding to the latest updated novel chapters. In response to triggering any of the novel catalogs, the complete chapter contents corresponding to the catalogs may be presented. Illustratively, presentation positions of the plurality of triggerable novel catalogs may be referred to presentation positions of the plurality of playable audio clips in f of FIG. 6, which will not be repeated here.

In this way, by innovating the dynamic interaction structures, it is possible to realize dynamically updating and presenting the second information content under different information distribution genres, thereby realizing the highlighting of the target key content under the target content distribution dimension corresponding to each information distribution genre, enriching the presented information content while considering the limited space of the presentation device, and improving the presentation efficiency of the presentation device.

In one embodiment, in order to realize the replacement in presenting the first information content and the second information content, a trigger operation for triggering the replacement presentation may also be provided. Specifically, the trigger operation may include an operation of triggering an information presentation button related to the first information content. After the information presentation button is triggered, it may be determined that the first information content needs to be replaced with the second information content. Specifically, for S101, the following steps may be performed:
presenting, on the information list page, the plurality of the first information contents, and presenting, at a position corresponding to the target content distribution dimension in the first information contents, an information presentation button corresponding to the target content distribution dimension.

Here, a first information content corresponds to an information presentation button, and a display position of the information presentation button in the first information content may specifically be the display position of the information presentation button in the first information content card. The display position of the information presentation button corresponding to the first information content may be determined according to the target content distribution dimension under the information distribution genre corresponding to the first information content, and the display position of the information presentation button in the first information content card may be the same or different when the target content distribution dimension is different.

For example, when the target content distribution dimension is the brief dimension, the display position of the information presentation button in the first information content card may be a target position in a region where a part of the brief information is located; when the target content distribution dimension is the video dimension, the display position of the information presentation button in the first information content card may be located in a video cover; when the target content distribution dimension is the catalog dimension and the audio dimension, the display position of the information presentation button in the first information content card may also be a target position in a region where the part of the brief information is located. Optionally, when the target content distribution dimension is the catalog dimension and the audio dimension, the display position of the information presentation button in the first information content card may also be a preset position of the first information content card, such as a top-left corner, a top-right corner, a bottom-left corner, and a bottom-right corner.

The information presentation buttons corresponding to different target content distribution dimensions may have different styles, for example, when the target content distribution dimension is the brief dimension, the information presentation button may have a style shown as the information presentation button in FIG. 4, i.e., “ [symbol] ”; when the target content distribution dimension is the video dimension, the information presentation button may have a style shown as the information presentation button in FIG. 5, i.e., a play button “ [symbol] ”. Specifically, the style of the information presentation button corresponding to the target content distribution dimension may be set according to experience, and the embodiments of the present disclosure do not impose specific limitations on the style.

Furthermore, for S102, the second information content corresponding to the first information content may be obtained in response to triggering the information presentation button corresponding to any one of the first information contents.

Illustratively, in response to triggering the information presentation button corresponding to the novel 1 in a in FIG. 4, the second information content 1 corresponding to the novel 1 may be obtained, and then, the first information content 1 corresponding to the novel 1 may be replaced with the second information content 1, thus obtaining the page as shown in b of FIG. 4.

As another example, in response to triggering the information presentation button corresponding to the movie or television drama 1 in c of FIG. 5, the second information content 5 corresponding to the movie or television drama 1 may be obtained, and then, the first information content 5 corresponding to the movie or television drama 1 may be replaced with the second information content 5, thus obtaining the page as shown in d of FIG. 5.

In another embodiment, the trigger operation may further include receiving a target gesture operation. Illustratively, different target gesture operations may be set in advance for different information distribution genres. Furthermore, for S102, in response to receiving the target gesture operation, the second information content corresponding to the first information content may be obtained, where a target content distribution dimension of target content information in the second information content is related to the target gesture operation and the information distribution genre.

Illustratively, on the information list page, when a plurality of first information contents presented are all of the same information distribution genre, in response to the target gesture operation, the first information content corresponding to the target gesture operation may be determined based on an execution position corresponding to the target gesture operation, and the distance corresponding to each of the first information contents, respectively. Then, the second information content corresponding to the first information content is obtained, and the first information content is replaced with the second information content.

On the information list page, when the plurality of first information contents presented are of different information distribution genres, in response to the target gesture operation, a target information distribution genre corresponding to the target gesture operation may be determined, and then the second information content corresponding to the first information content under the target information distribution genre may be obtained and the first information content under the target information distribution genre may be replaced with the second information content.

In this way, the change of the information structure is triggered by the target gesture operation, making the change of the information structure flexible, and facilitating the improvement of user experience.

A person skilled in the art can understand that, in the specific implementation of the above-mentioned method, the writing order of the steps does not imply a strict order of execution and does not constitute any limitation of the implementation process, and the specific execution order of the steps should be determined by its function and possible internal logic.

Based on the same inventive concept, an embodiment of the present disclosure further provides an information presentation apparatus corresponding to the information presentation method. Since the apparatus in the embodiment of the present disclosure solves the problem in a similar way to the information presentation method in the embodiment of the present disclosure, the implementation of the apparatus may refer to the implementation of the method, and repeated descriptions are omitted.

FIG. 7 shows a schematic diagram of an information presentation apparatus according to an embodiment of the present disclosure. The information presentation apparatus includes:
a first presentation module 701, configured to present, on an information list page, a plurality of first information contents, where the first information contents have a preset first information structure;
an obtaining module 702, configured to obtain, in response to a trigger operation for any one of the first information contents, a second information content corresponding to the first information content, where the second information content has a preset second information structure, the second information structure has a different form of presenting a target key content in a content detail corresponding to the first information content compared to the first information structure, and the target key content is related to the information distribution genre of the first information content; and
a second presentation module 703, configured to update and present the second information content at the position of the first information content.

In a possible implementation, the respective content distribution dimensions corresponding to the first information structure are the same as or different from the respective content distribution dimensions corresponding to the second information structure; under different information distribution genres, a target content distribution dimension to which the target key content belongs is different.

In a possible implementation, in case of the information distribution genre being a text content category, the target content distribution dimension is a brief dimension;
in case of the information distribution genre being a movie or television drama category, the target content distribution dimension is a video dimension;
in case of the information distribution genre being a serials category, the target content distribution dimension is a catalog dimension; and
in case of the information distribution genre being an audio program category, the target content distribution dimension is an audio dimension.

In a possible implementation, in case of the information distribution genre being the text content category, the first presentation module 701, in the process of presenting, on an information list page, a plurality of first information contents, is configured to:
present, on the information list page, a plurality of first information content cards, the first information content cards each presenting a title, a cover, and a part of brief information of the first information contents, where the sum of the occupancy sizes of the title and the cover in a horizontal direction of the page, or the sum of the occupancy sizes of the cover and the part of brief information in the horizontal direction of the page is equal to the width of the first information content card in the horizontal direction of the page, respectively.

The second presentation module 703, in the process of updating and presenting the second information content at the position of the first information content, is configured to:
replace each first information content card with a second information content card, the second information content card presenting a title, a cover, and complete brief information of the second information contents; where the occupancy size of the complete brief information in the horizontal direction of the page is equal to the width of the second information content card in the horizontal direction of the page; and the sum of the occupancy sizes of the title and the cover is equal to the width of the second information content card in the horizontal direction of the page.

In a possible implementation, in case of the information distribution genre being the movie or television drama category, the first presentation module 701, in the process of presenting, on an information list page, a plurality of first information contents, is configured to
present, on the information list page, a plurality of first information content cards, the first information content cards each presenting a video title, a video cover, and a part of brief information of the first information contents, where the sum of the occupancy sizes of the video title and the video cover in the horizontal direction of the page as well as the sum of the occupancy sizes of the video cover and the part of brief information in the horizontal direction of the page, is equal to the width of the first information content card in the horizontal direction of the page, respectively.

The second presentation module 703, in the process of updating and presenting the second information content at the position of the first information content, is configured to:
replace each first information content card with a second information content card, the second information content card presenting a video title, a preview video in a playing state, and a part of brief information of the second information content, where the occupancy sizes of the video title, the preview video, and the part of brief information in the horizontal direction of the page are each equal to the width of the second information content card in the horizontal direction of the page.

In a possible implementation, in case of the information distribution genre being the audio program category, the first presentation module 701, in the process of presenting, on an information list page, a plurality of first information contents, is configured to
present, on the information list page, a plurality of first information content cards, the first information content cards each presenting a title, a cover, and a part of brief information of the first information contents, where the sum of the occupancy sizes of the title and the cover in the horizontal direction of the page as well as the sum of the occupancy sizes of the cover and the part of brief information in the horizontal direction of the page is equal to the width of the first information content card in the horizontal direction of the page, respectively.

The second presentation module 703, in the process of updating and presenting the second information content at the position of the first information content, is configured to:
replace each first information content card with a second information content card, the second information content card presenting a title, a cover and complete brief information of the second information contents and a plurality of playable audio clips; where the sum of the occupancy sizes of the plurality of audio clips in the horizontal direction of the page, or the occupancy size of the complete brief information in the horizontal direction of the page, is equal to the width of the second information content card in the horizontal direction of the page, respectively, and the sum of the occupancy sizes of the title and the cover in the horizontal direction of the page is equal to the width of the second information content card in the horizontal direction of the page.

In a possible implementation, the trigger operation includes an operation of triggering an information presentation button associated with the first information contents.

The first presentation module 701, in the process of presenting, on an information list page, a plurality of first information contents, is configured to:
present, on the information list page, the plurality of the first information contents, and presenting, at a position corresponding to the target content distribution dimension in the first information contents, an information presentation button corresponding to the target content distribution dimension.

The obtaining module 702, in the process of obtaining, in response to a trigger operation for any one of the first information contents, a second information content corresponding to the first information content, is configured to:
obtain, in response to triggering the information presentation button corresponding to any one of the first information contents, a second information content corresponding to the first information content.

In a possible implementation, the trigger operation includes receiving a target gesture operation.

The obtaining module 702, in the process of obtaining, in response to a trigger operation for any one of the first information contents, a second information content corresponding to the first information content, is configured to:
obtain, in response to receiving the target gesture operation, a second information content corresponding to the first information content; where the target content distribution dimension of target content information in the second information content is related to the target gesture operation and the information distribution genre.

The descriptions of processing flows of the modules and the interaction flows between the modules in the apparatus may be referred to the relevant descriptions in the above-mentioned method embodiments, and will not be described in detail herein.

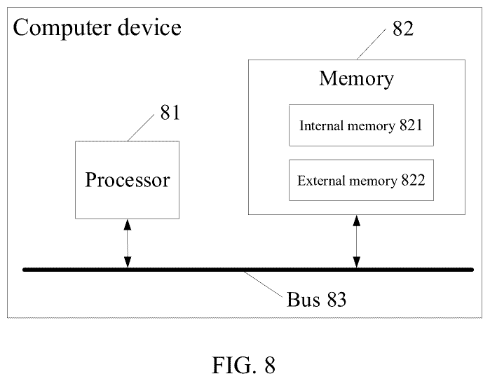

Based on the same technical concept, an embodiment of the present disclosure further provides a computer device. Reference is made to FIG. 8, which is a schematic structural diagram of a computer device according to an embodiment of the present disclosure. The computer device includes:
a processor 81, a memory 82 and a bus 83. The memory 82 stores machine-readable instructions executable by the processor 81, the processor 81 is configured to execute the machine-readable instructions stored in the memory 82, and when the machine-readable instructions are executed by the processor 81, the processor 81 performs the following steps: S101: presenting, on an information list page, a plurality of first information contents, where the first information contents have a preset first information structure; S102: obtaining, in response to a trigger operation for any one of the first information contents, a second information content corresponding to the first information content, where the second information content has a preset second information structure, the second information structure has a different form of presenting a target key content in a content detail corresponding to the first information content compared to the first information structure, and the target key content is related to the information distribution genre of the first information content; and S103: updating and presenting the second information content at the position of the first information content.

The memory 82 described above includes an internal memory 821 and external memory 822. The internal memory 821, also referred to as internal storage, is used for temporary storage of computing data in the processor 81, as well as data exchanged with the external memory 822, such as a hard disk. The processor 81 exchanges data with external memory 822 through the internal memory 821. During operation of the computer device, the processor 81 is in communication with the memory 82 via bus 83, causing the processor 81 to execute the instructions mentioned in the foregoing method embodiments.

An embodiment of the present disclosure further provides a computer-readable storage medium, the computer-readable storage medium storing a computer program. When the computer program is run by a processor, the steps of the information presentation method described in the method embodiments above are performed. The storage medium may be a volatile or non-volatile computer-readable storage medium.

A computer program product using the information presentation method provided in the embodiments of the present disclosure includes a computer-readable storage medium storing program code; the program code includes instructions that may be configured to execute the steps of the information presentation method described in the above-mentioned method embodiments, which may be specified in the above-mentioned method embodiments, and will not be repeated herein.

The computer program product may be implemented specifically by hardware, software, or a combination thereof. In an optional embodiment, the computer program product is embodied as a computer storage medium, and in another optional embodiment, the computer program product is embodied as a software product, such as a Software Development Kit (SDK), etc.

Those skilled in the art could clearly understand that for the specific working process of the apparatus described above, reference can be made to the corresponding processes in the aforesaid method embodiment for ease and brevity of the description, and no further description is given here. In several embodiments provided in the present disclosure, it should be understood that the disclosed apparatus and method can be realized by other means. The apparatus embodiment described above is only schematic. For example, the division of units is merely a logical function division, and other division modes may exist during actual implementation. For another example, a plurality of units or components can be combined, or some features can be ignored, or not executed. On the other hand, coupling or direct coupling or communicative connection between what is shown or discussed may be indirect coupling or communicative connection through some communication interfaces, apparatuses or units, and may be in electrical, mechanical or other forms.

The units described as discrete components may or may not be physically separated, and the components displayed as units may or may not be physical units, that is, may be co-located, or may also be distributed on a plurality of network units. Some or all of these units may be chosen according to actual needs to realize the purpose of the solution of the present embodiment.

In addition, functional units in various embodiments of the present disclosure may be integrated in one processing unit, or these units may also physically exist independently of each other, or two or more units may also be integrated in one unit.

If implemented in the form of a software function unit and marketed or used as a standalone product, the function may be stored in a processor-executable nonvolatile computer-readable storage medium. Based upon this understanding, the technical solution of the present disclosure, in essence, or contributions to the existing technology, or part of this technical solution may be embodied in the form of a software product, which is stored in a storage medium and includes a number of instructions to enable a computer device (which may be a personal computer, a server, or a network device, etc.) to perform all or some of the steps of the method described in each embodiment of the present disclosure. The aforementioned storage medium includes: a variety of media capable of storing program codes, such as USB flash drive, portable hard disk, Read-Only Memory (ROM), Random Access Memory (RAM), magnetic disk, optical disc, or the like.

If the technical solution of the present disclosure involves personal information, the product applying the technical solution of the present disclosure has clearly informed the rules of handling personal information and obtained the individual's consent before handling personal information. If the technical solution of the present disclosure involves sensitive personal information, the product applying the technical solution of the present disclosure has obtained the individual's consent before handling the sensitive personal information while meeting the requirement of “express consent”. For example, at a personal information collection apparatus such as a camera, a clear and conspicuous sign is set up to inform the user that he/she has entered the scope of personal information collection and that personal information will be collected, and individuals who voluntarily enter the scope of collection are deemed to have consented to the collection of their personal information; or on the personal information processing apparatus, the rules for personal information processing are communicated using visible signs/information, authorization is obtained from individuals through pop-up messages or by asking individuals to upload their personal information on their own. The rules for personal information processing may include information on the person who processes personal information, the purpose of personal information processing, the processing manner, and the types of personal information to be processed.

Finally, it should be noted that the above-mentioned embodiments are only specific implementations of the present disclosure and used to illustrate the technical solutions of the present disclosure, and are not intended to limit the present disclosure; and the protection scope of the present disclosure is not limited thereto; although the present disclosure has been described in detail with reference to the foregoing embodiments, a person of ordinary skilled in the art should understand that within the technical scope disclosed in the present disclosure, any person of skill familiar with the technical field can still modify or conceive of changes to the technical solutions recorded in the foregoing embodiments, or make equivalent substitutions for some of the technical features therein; and these modifications, changes or substitutions do not cause the essence of the corresponding technical solutions to deviate from the spirit and scope of the technical solutions of the embodiments of the present disclosure, all of which shall be covered within the protection scope of the present disclosure. Therefore, the protection scope of the present disclosure shall be subject to the protection scope of the claims.

1. An information presentation method, comprising:
presenting, on an information list page, a plurality of first information contents, wherein the first information contents have a preset first information structure;
obtaining, in response to a trigger operation for any one of the first information contents, a second information content corresponding to a first information content, wherein the second information content has a preset second information structure, the second information structure has a different form of presenting a target key content in a content detail corresponding to the first information content as compared to the first information structure, and the target key content is related to an information distribution genre of the first information content; and
updating and presenting the second information content at a position of the first information content.

2. The method of claim 1, wherein respective content distribution dimensions corresponding to the first information structure are same as or different from respective content distribution dimensions corresponding to the second information structure; under different information distribution genres, a target content distribution dimension to which the target key content belongs is different.

3. The method of claim 2, wherein,
in case of the information distribution genre being a text content category, the target content distribution dimension is a brief dimension;
in case of the information distribution genre being a movie or television drama category, the target content distribution dimension is a video dimension;
in case of the information distribution genre being a serials category, the target content distribution dimension is a catalog dimension; and
in case of the information distribution genre being an audio program category, the target content distribution dimension is an audio dimension.

4. The method of claim 3, wherein, in case of the information distribution genre being a text content category, presenting, on an information list page, a plurality of first information contents comprises:
presenting, on an information list page, a plurality of first information content cards, the first information content cards each presenting a title, a cover, and a part of brief information of the first information contents, wherein a sum of sizes of the title and the cover in a horizontal direction of the information list page, as well as a sum of sizes of the cover and the part of brief information in the horizontal direction of the information list page, is equal to a width of the first information content card in the horizontal direction of the information list page, respectively;
updating and presenting the second information content at a position of the first information content comprises:
replacing each first information content card with a second information content card, the second information content card presenting a title, a cover, and complete brief information of the second information content; wherein a size of the complete brief information in the horizontal direction of the information list page is equal to a width of the second information content card in the horizontal direction of the information list page; and a sum of sizes of the title and the cover is equal to the width of the second information content card in the horizontal direction of the information list page.

5. The method of claim 3, wherein, in case of the information distribution genre being a movie or television drama category, presenting, on an information list page, a plurality of first information contents, comprises:
presenting, on an information list page, a plurality of first information content cards, the first information content cards each presenting a video title, a video cover, and a part of brief information of the first information contents, wherein a sum of sizes of the video title and the video cover in a horizontal direction of the information list page, as well as a sum of sizes of the video cover and the part of brief information in the horizontal direction of the information list page is equal to a width of the first information content card in the horizontal direction of the information list page, respectively;
updating and presenting the second information content at a position of the first information content comprises:
replacing each first information content card with a second information content card, the second information content card presenting a video title, a preview video in a playing state, and a part of brief information of the second information content, wherein occupancy sizes of the video title, the preview video, and the part of brief information in the horizontal direction of the information list page are each equal to a width of the second information content card in the horizontal direction of the information list page.

6. The method of claim 3, wherein, in case of the information distribution genre being an audio program category, presenting, on an information list page, a plurality of first information contents, comprises:
presenting, on an information list page, a plurality of first information content cards, the first information content cards each presenting a title, a cover, and a part of brief information of the first information contents, wherein a sum of occupancy sizes of the title and the cover in a horizontal direction of the information list page, as well as a sum of occupancy sizes of the cover and the part of brief information in the horizontal direction of the information list page is equal to a width of the first information content card in the horizontal direction of the information list page, respectively;
updating to present the second information content at the position of the first information content comprises:
replacing each first information content card with a second information content card, the second information content card presenting a title, a cover and complete brief information of the second information contents and a plurality of playable audio clips; wherein a sum of sizes of the plurality of audio clips in the horizontal direction of the information list page, or a size of the complete brief information in the horizontal direction of the information list page, is equal to a width of the second information content card in the horizontal direction of the information list page, respectively, and a sum of sizes of the title and the cover in the horizontal direction of the information list page is equal to the width of the second information content card in the horizontal direction of the information list page.

7. The method of claim 2, wherein the trigger operation comprises an operation of triggering an information presentation button associated with the first information contents;
presenting, on an information list page, a plurality of first information contents comprises:
presenting, on the information list page, a plurality of the first information contents, and presenting, at a position corresponding to the target content distribution dimension in the first information contents, an information presentation button corresponding to the target content distribution dimension;
obtaining, in response to a trigger operation for any one of the first information contents, a second information content corresponding to the first information content comprises:
obtaining, in response to triggering the information presentation button corresponding to any one of the first information contents, a second information content corresponding to the first information content.

8. The method of claim 1, wherein the trigger operation comprises receiving a target gesture operation;
obtaining, in response to a trigger operation for any one of the first information contents, a second information content corresponding to the first information content comprises:
obtaining, in response to receiving a target gesture operation, a second information content corresponding to the first information content; wherein a target content distribution dimension of target content information in the second information content is related to the target gesture operation and the information distribution genre.

9. (canceled)

10. A computer device, comprising a processor and a memory, wherein the memory stores machine-readable instructions executable by the processor, the processor is configured to execute the machine-readable instructions stored in the memory, and when the machine-readable instructions are executed by the processor, the processor performs information presentation operations, the operations comprising:
presenting, on an information list page, a plurality of first information contents, wherein the first information contents have a preset first information structure;
obtaining, in response to a trigger operation for any one of the first information contents, a second information content corresponding to a first information content, wherein the second information content has a preset second information structure, the second information structure has a different form of presenting a target key content in a content detail corresponding to the first information content as compared to the first information structure, and the target key content is related to an information distribution genre of the first information content; and
updating and presenting the second information content at a position of the first information content.

11. A non-transitory computer-readable storage medium, wherein the computer-readable storage medium stores a computer program which, when executed by a computer device, causing the computer device to perform information presentation operations, the operations comprising:
presenting, on an information list page, a plurality of first information contents, wherein the first information contents have a preset first information structure;
obtaining, in response to a trigger operation for any one of the first information contents, a second information content corresponding to a first information content, wherein the second information content has a preset second information structure, the second information structure has a different form of presenting a target key content in a content detail corresponding to the first information content as compared to the first information structure, and the target key content is related to an information distribution genre of the first information content; and
updating and presenting the second information content at a position of the first information content.

12. The computer device of claim 10, wherein respective content distribution dimensions corresponding to the first information structure are same as or different from respective content distribution dimensions corresponding to the second information structure; under different information distribution genres, a target content distribution dimension to which the target key content belongs is different.

13. The computer device of claim 12, wherein,
in case of the information distribution genre being a text content category, the target content distribution dimension is a brief dimension;
in case of the information distribution genre being a movie or television drama category, the target content distribution dimension is a video dimension;
in case of the information distribution genre being a serials category, the target content distribution dimension is a catalog dimension; and
in case of the information distribution genre being an audio program category, the target content distribution dimension is an audio dimension.

14. The computer device of claim 13, wherein, in case of the information distribution genre being a text content category, presenting, on an information list page, a plurality of first information contents comprises:
presenting, on an information list page, a plurality of first information content cards, the first information content cards each presenting a title, a cover, and a part of brief information of the first information contents, wherein a sum of sizes of the title and the cover in a horizontal direction of the information list page, as well as a sum of sizes of the cover and the part of brief information in the horizontal direction of the information list page, is equal to a width of the first information content card in the horizontal direction of the information list page, respectively;
updating and presenting the second information content at a position of the first information content comprises:
replacing each first information content card with a second information content card, the second information content card presenting a title, a cover, and complete brief information of the second information content; wherein a size of the complete brief information in the horizontal direction of the information list page is equal to a width of the second information content card in the horizontal direction of the information list page; and a sum of sizes of the title and the cover is equal to the width of the second information content card in the horizontal direction of the information list page.

15. The computer device of claim 13, wherein, in case of the information distribution genre being a movie or television drama category, presenting, on an information list page, a plurality of first information contents, comprises:
presenting, on an information list page, a plurality of first information content cards, the first information content cards each presenting a video title, a video cover, and a part of brief information of the first information contents, wherein a sum of sizes of the video title and the video cover in a horizontal direction of the information list page, as well as a sum of sizes of the video cover and the part of brief information in the horizontal direction of the information list page is equal to a width of the first information content card in the horizontal direction of the information list page, respectively;
updating and presenting the second information content at a position of the first information content comprises:
replacing each first information content card with a second information content card, the second information content card presenting a video title, a preview video in a playing state, and a part of brief information of the second information content, wherein occupancy sizes of the video title, the preview video, and the part of brief information in the horizontal direction of the information list page are each equal to a width of the second information content card in the horizontal direction of the information list page.

16. The computer device of claim 13, wherein, in case of the information distribution genre being an audio program category, presenting, on an information list page, a plurality of first information contents, comprises:
presenting, on an information list page, a plurality of first information content cards, the first information content cards each presenting a title, a cover, and a part of brief information of the first information contents, wherein a sum of occupancy sizes of the title and the cover in a horizontal direction of the information list page, as well as a sum of occupancy sizes of the cover and the part of brief information in the horizontal direction of the information list page is equal to a width of the first information content card in the horizontal direction of the information list page, respectively;
updating to present the second information content at the position of the first information content comprises:
replacing each first information content card with a second information content card, the second information content card presenting a title, a cover and complete brief information of the second information contents and a plurality of playable audio clips; wherein a sum of sizes of the plurality of audio clips in the horizontal direction of the information list page, or a size of the complete brief information in the horizontal direction of the information list page, is equal to a width of the second information content card in the horizontal direction of the information list page, respectively, and a sum of sizes of the title and the cover in the horizontal direction of the information list page is equal to the width of the second information content card in the horizontal direction of the information list page.

17. The computer device of claim 12, wherein the trigger operation comprises an operation of triggering an information presentation button associated with the first information contents;
presenting, on an information list page, a plurality of first information contents comprises:
presenting, on the information list page, a plurality of the first information contents, and presenting, at a position corresponding to the target content distribution dimension in the first information contents, an information presentation button corresponding to the target content distribution dimension;
obtaining, in response to a trigger operation for any one of the first information contents, a second information content corresponding to the first information content comprises:
obtaining, in response to triggering the information presentation button corresponding to any one of the first information contents, a second information content corresponding to the first information content.

18. The computer device of claim 10, wherein the trigger operation comprises receiving a target gesture operation;
obtaining, in response to a trigger operation for any one of the first information contents, a second information content corresponding to the first information content comprises:
obtaining, in response to receiving a target gesture operation, a second information content corresponding to the first information content; wherein a target content distribution dimension of target content information in the second information content is related to the target gesture operation and the information distribution genre.

19. The storage medium of claim 11, wherein respective content distribution dimensions corresponding to the first information structure are same as or different from respective content distribution dimensions corresponding to the second information structure; under different information distribution genres, a target content distribution dimension to which the target key content belongs is different.

20. The storage medium of claim 19, wherein,
in case of the information distribution genre being a text content category, the target content distribution dimension is a brief dimension;
in case of the information distribution genre being a movie or television drama category, the target content distribution dimension is a video dimension;
in case of the information distribution genre being a serials category, the target content distribution dimension is a catalog dimension; and
in case of the information distribution genre being an audio program category, the target content distribution dimension is an audio dimension.

21. The storage medium of claim 20, wherein, in case of the information distribution genre being a text content category, presenting, on an information list page, a plurality of first information contents comprises:
presenting, on an information list page, a plurality of first information content cards, the first information content cards each presenting a title, a cover, and a part of brief information of the first information contents, wherein a sum of sizes of the title and the cover in a horizontal direction of the information list page, as well as a sum of sizes of the cover and the part of brief information in the horizontal direction of the information list page, is equal to a width of the first information content card in the horizontal direction of the information list page, respectively;
updating and presenting the second information content at a position of the first information content comprises:
replacing each first information content card with a second information content card, the second information content card presenting a title, a cover, and complete brief information of the second information content; wherein a size of the complete brief information in the horizontal direction of the information list page is equal to a width of the second information content card in the horizontal direction of the information list page; and a sum of sizes of the title and the cover is equal to the width of the second information content card in the horizontal direction of the information list page.
